(19) United States
(12) Patent Application Publication
(10) Pub. No.: US 2014/0137685 A1
(43) Pub. Date: May 22, 2014

(54) CABLE ARRANGEMENT STRUCTURE OF MULTI-JOINT ROBOT

(71) Applicant: FANUC CORPORATION, Yamanashi (JP)

(72) Inventor: Takatoshi IWAYAMA, Yamanashi (JP)

(73) Assignee: FANUC CORPORATION, Yamanashi (JP)

(21) Appl. No.: 14/081,405

(22) Filed: Nov. 15, 2013

Related U.S. Application Data
(60) Provisional application No. 61/731,055, filed on Nov. 29, 2012.

(30) Foreign Application Priority Data
Nov. 16, 2012 (JP) 2012-252148

(51) Int. Cl. B25J 18/00

(52) U.S. Cl. CPC B25J 18/00; Y10S 901/27
USPC 74/490.02; 901/27

(57) ABSTRACT

A cable arrangement structure capable of properly arranging a motor-drive cable while preventing a robot from being complicated and increased in size. Among first to sixth motor-drive cables, at least first to third motor-drive cables are introduced to a cable outlet formed on at least one of a rotating body, a first arm and a second arm. The motor-drive cables, introduced to the outlet, are withdrawn outside the robot as a cable bundle or separate cables, and are connected to a robot controller positioned separately from the robot.

### BACKGROUND OF THE INVENTION

1. Field of the Invention

The preset invention relates to an arrangement structure of a motor-drive cable for a motor which drives each axis of a multi-joint robot.

2. Description of the Related Art

When a multi-joint robot is used for welding, painting or handling operation of an article, etc., a conduit or pipe must be arranged on or around the robot for supplying power or means required for the operation. For example, Japanese Unexamined Patent Publication (Kokai) No. H08-174223 discloses a configuration wherein a support member fastened to a conduit cable by means of a band is suspended by an elastic member hung from a generally horizontal support beam which is supported by a base.

On the other hand, Japanese Unexamined Patent Publication (Kokai) No. 2006-015360 discloses a configuration wherein a torch cable is elastically suspended by using a sprig hung from a ceiling.

In the multi-joint robot as disclosed in Japanese Unexamined Patent Publication (Kokai) No. H08-174223 or Japanese Unexamined Patent Publication (Kokai) No. 2006-015360, it is normal that a conduit such as a torch cable is suspended by a suitable means, while a motor-drive cable for supplying power or signals to a motor for driving each axis be withdrawn from a base of the robot toward a rear side thereof (or a counter- operation side) of the robot (see FIG. 4 as described below). Therefore, when the multi-joint robot is designed, both arrangement of the motor-drive cable and positioning of the means for suspending the conduit must be considered, whereby the design of the robot becomes complex.

Further, since the motor-drive cable must be arranged so that a rotating body of the robot can rotate over a predetermined angular range (normally, ±180 degrees), a complicated structure such as a guide or protect member for the cable are necessary, whereby there is a problem in assembling or maintenance of the robot. Also, as shown in FIG. 4, when a space is formed within the base so that the cable can move within a predetermined range, the base may be enlarged.

### SUMMARY OF THE INVENTION

Therefore, an object of the present invention is to provide a cable arrangement structure capable of properly arranging a motor-drive cable while preventing a robot from being complicated and increased in size.

According the present invention, there is provided a cable arrangement structure for a multi-joint robot comprising: a base; a rotating body attached to the base so as to rotate relative to the base; a first arm attached to the rotating body so as to rotate or linearly move relative to the rotating body; and a second arm connected to the first arm so as to rotate or linearly move relative to the first arm, wherein a motor-drive cable is introduced from each motor to a cable outlet which is formed only on at least one of the rotating body, the first arm and the second arm; is withdrawn from the cable outlet; and is connected to a robot controller for controlling the multi-joint robot, the motor-drive cable being constituted by a power cable for supplying power to each of motors for respectively driving the rotating body, the first arm and the second arm, and a signal cable for transmitting and/or receiving a signal to and/or from each of the motors.

In a preferred embodiment, the motor-drive cable is introduced from each motor to the cable outlet which is formed only on one of the rotating body, the first arm and the second arm; is withdrawn from the cable outlet; and is connected to the robot controller for controlling the multi-joint robot.

In a preferred embodiment, a motor-drive cable is introduced from each motor to a cable outlet which is formed only on at least one of the rotating body, the first arm and the second arm; is withdrawn from the cable outlet; and is connected to a robot controller for controlling the multi-joint robot, the motor-drive cable being constituted by a power cable for supplying power to each of all motors provided to the multi-joint robot, and a signal cable for transmitting a signal to each of the all motors.

In a preferred embodiment, the cable arrangement structure comprises a suspending member which suspends the motor-drive cable between the multi-joint robot and the robot controller.

In a preferred embodiment, the cable arrangement structure comprises a relay member positioned between the motor and the robot controller, the relay member being configured to be detachably connected to the motor-drive cable.

In a preferred embodiment, the cable arrangement structure comprises a protective member which covers a portion of the motor-drive cable between the multi-joint robot and the robot controller. In a preferred embodiment, the multi-joint robot is an arc-welding robot, a spot-welding robot, a material handling robot or a painting robot.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 is a view showing a schematic configuration of a multi-joint robot having a cable arrangement structure according to a first embodiment of the invention;

FIG. 2 is a view showing a schematic configuration of a multi-joint robot having a cable arrangement structure according to a second embodiment of the invention;

FIG. 3a is a view showing a schematic configuration of a multi-joint robot having a cable arrangement structure according to a third embodiment of the invention;

FIG. 3b is a view of the configuration of FIG. 3a viewed from a different angle;

FIG. 3 is a view schematically showing the umbilical member arrangement structure of the invention;

FIG. 4 is a view showing a comparative example wherein an inner space is arranged in a base;

FIG. 5 is a view showing an example wherein a cable outlet is formed on a position of a second arm which is different from a position of FIG. 1;

FIG. 6 is a view showing an example wherein a cable outlet is formed on a position of a second arm which is different from positions of FIGS. 1 and 5;

FIG. 7 is a view showing an example wherein a cable outlet is formed on a position of a rotating body which is different from a position of FIG. 2;

FIG. 8 is a view showing an example of a multi-joint robot wherein first and second arms are linearly moved;

FIG. 9 is a view showing an example wherein the multi-joint is an arc-welding robot;

FIG. 10 is a view showing an example wherein a relay box is used instead of a relay connector of FIG. 9;

FIG. 11 is a view showing an example of a wire-feeder wherein the position thereof is different from the position of FIG. 9;

FIG. 12 is a view showing an example wherein a cable hanger is attached to the second arm;

FIG. 13 is a view showing another example of the cable hanger;

FIG. 14 is a view showing still another example of the cable hanger;

FIG. 15 is a view showing still another example of the cable hanger;

FIG. 16 is a view showing still another example of the cable hanger;

FIG. 17 is a view showing an example wherein the multi-joint is a material handling robot; and

FIG. 18 is a view showing an example wherein the multi-joint is a painting robot.

### DETAILED DESCRIPTIONS

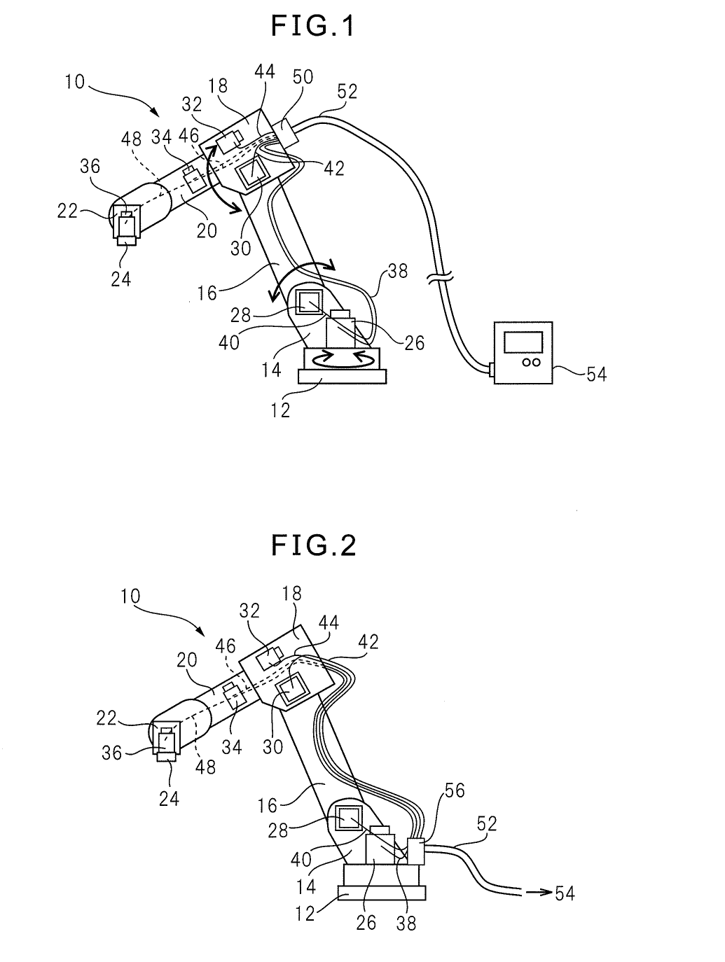

FIG. 1 shows a schematic configuration of a multi-joint robot having a cable arrangement structure according to a first embodiment of the present invention. A multi-joint robot 10 has a base 12; a rotating body 14 attached to base 12 so as to rotate relative to base 12; a first arm 16 connected to rotating body 14 so as to rotate relative to rotating body 14; and a second arm 18 connected to first arm 16 so as to rotate relative to first arm 16. In this embodiment, robot 10 is a multi-joint robot with six axes. Concretely, robot 10 may have a first wrist element 20 rotatably attached to second arm 18, a second wrist element 22 rotatably attached to first wrist element 20, and a third wrist element 24 rotatably attached to second wrist element 22.

A motor for driving each axis of robot 10 is positioned on or near a component to be driven by the motor. In the embodiment, first to sixth motors 26, 28, 30, 32, 34 and 36 correspond to motors for driving rotating body 14 (a first axis), first arm 16 (a second axis), second arm 18 (a third axis), first wrist element 20 (fourth axis), second wrist element 22 (fifth axis) and third wrist element 24 (sixth axis), respectively.

A motor-drive cable is connected to each motor as described above, wherein the motor-drive cable is constituted by a power cable for supplying power to each motor and a signal cable for transmitting and/or receiving a signal to and/or from each motor. Concretely, first to sixth motor-drive cables 38, 40, 42, 44, 46 and 48 are connected to first to sixth motors 26, 28, 30, 32, 34 and 36, respectively.

Among the first to sixth motor-drive cables as described above, at least first to third motor-drive cables 38, 40 and 42 (all cables in the drawing) are introduced to a cable outlet 50 formed on second arm 18. In this regard, from each motor to outlet 50, each cable may extend through a robot component (or a mechanical unit) such as the arm or the wrist element, or, may be arranged along the outside the robot component. The motor-drive cables, introduced to outlet 50 as such, are withdrawn outside the robot as a cable bundle 52 or separate cables, and are connected to a robot controller 54 positioned separately from robot 10. When the motor-drive cables are constituted as cable bundle 52, the plurality of (six in this case) motor-drive cables may be collectively inserted into a protective member such as a flexible tube, etc., whereby the cables can be protected from damage due to friction with peripherals.

FIG. 2 shows a schematic configuration of a multi-joint robot having a cable arrangement structure according to a second embodiment of the present invention. The second embodiment is different from the first embodiment in that the cable outlet is formed on rotating body 14, not on second arm 18. Therefore, among the first to sixth motor-drive cables, at least first to third motor-drive cables 38, 40 and 42 (all cables in the drawing) are introduced to a cable outlet 56 formed on rotating body 14. In this regard, from each motor to outlet 56, each cable may extend through a robot component (or a mechanical unit) such as the arm or the wrist element, or, may be arranged along the outside the robot component. The motor-drive cables, introduced to outlet 56 as such, are withdrawn outside the robot as cable bundle 52 or separate cables, and are connected to robot controller 54 positioned separately from robot 10. Since the other components of the second embodiment may be the same as the first embodiment, each component in the second embodiment corresponding to the component in the first embodiment is provided with the same reference numeral as the first embodiment, and the detailed explanation thereof is omitted.

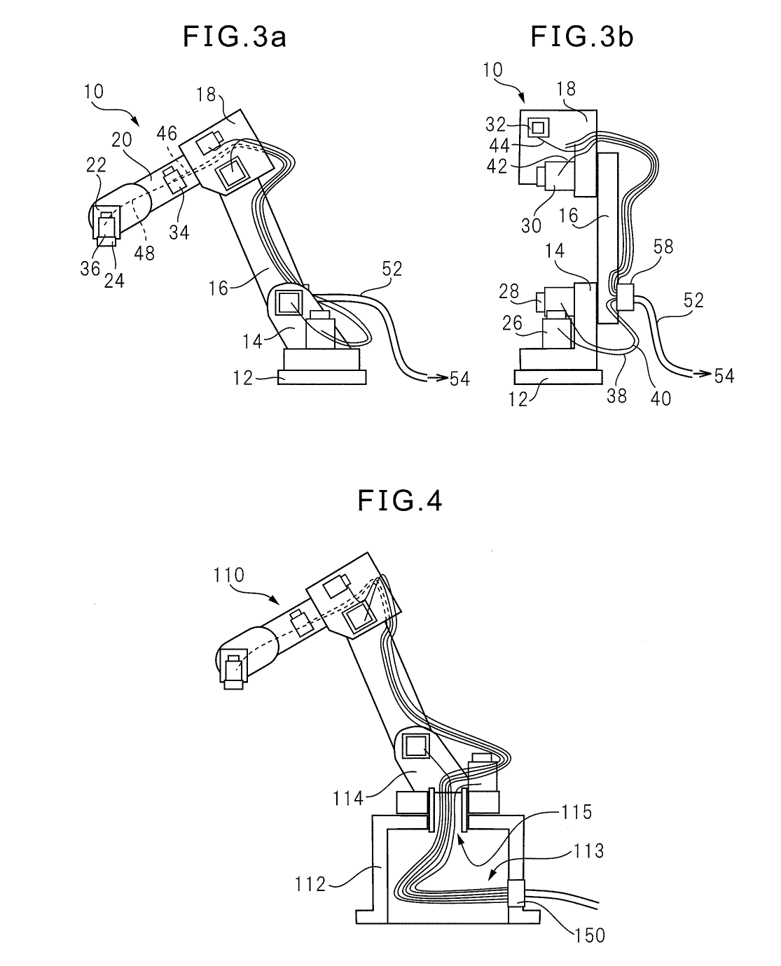

FIGS. 3a and 3b show a schematic configuration of a multi-joint robot having a cable arrangement structure according to a third embodiment of the present invention. The third embodiment is different from the first or second embodiment in that the cable outlet is formed on first arm 16, not on rotating body 14 or second arm 18. Therefore, among the first to sixth motor-drive cables, at least first to third motor-drive cables 38, 40 and 42 (all cables in the drawing) are introduced to a cable outlet 58 formed on first arm 16. In this regard, from each motor to outlet 58, each cable may extend through a robot component (or a mechanical unit) such as the arm or the wrist element, or, may be arranged along the outside the robot component. The motor-drive cables, introduced to outlet 58 as such, are withdrawn outside the robot as cable bundle 52 or separate cables, and are connected to robot controller 54 positioned separately from robot 10. Since the other components of the third embodiment may be the same as the first and second embodiments, each component in the third embodiment corresponding to the component in the first and second embodiments is provided with the same reference numeral as the first and embodiments, and a detailed explanation thereof is omitted.

As explained in the first, second and third embodiments, in the present invention, among the (six in the embodiment) motor-drive cables of the robot, at least first to third motor-drive cables 38, 40 and 42 (respectively connected to first, second and third motors 26, 28 and 30 for driving rotating body 14, first arm 16 and second arm 18, respectively), are introduced to the cable outlet formed only on at least one of the rotating body, the first arm and the second arm; is withdrawn from the cable outlet; and is connected to robot controller 54. Although only one cable outlet is formed in any of the above embodiments, two or three of the rotating body, the first arm and the second arm may have the cable outlet. In other words, in the invention, a cable outlet is not formed on any component other than rotating body 14, first arm 16 and second arm 18.

A remarkable effect of the invention is explained with reference to a comparative example as shown in FIG. 4. In a multi-joint robot of the prior art, such as a robot 110 exemplified in FIG. 4, a base 112 has a relatively large inner space 113. Then, a cable from each motor is introduced into inner space 113 via a through hole 115 formed on base 112, is withdrawn from inner space 113 via an outlet 150 formed on base 112, and is connected to a controller (not shown). However, in the configuration of FIG. 4, the structures of a rotating body 114 and base 112 are complicated, and base 112 is increased in size. The length and arrangement manner of the cable within inner space 113 must be predetermined in detail such that an excess stress is not applied to the cable when rotating body 114 is rotated over a wide range (for example, ±180 degrees). Further, an operation for inserting the cable into inner space 113 and through hole 115 is cumbersome, and the arrangement and exchange of the cable is troublesome.

On the other hand, in the present invention, since the cable outlet is formed only on at least one of rotating body 14, first arm 16 and second arm 18, the base is not required to be increased in size and the entire robot can be compact. Since it is not necessary to arrange the cable within a closed space such as inner space 113 of base 112, cabling and exchange of the cable are facilitated. Further, the stress applied to the cable due to the rotating motion of rotating body 14 may be accommodated by providing a margin to the cable between the outlet and controller, whereby a guide or protective member is not necessary for a movable part of the cable.

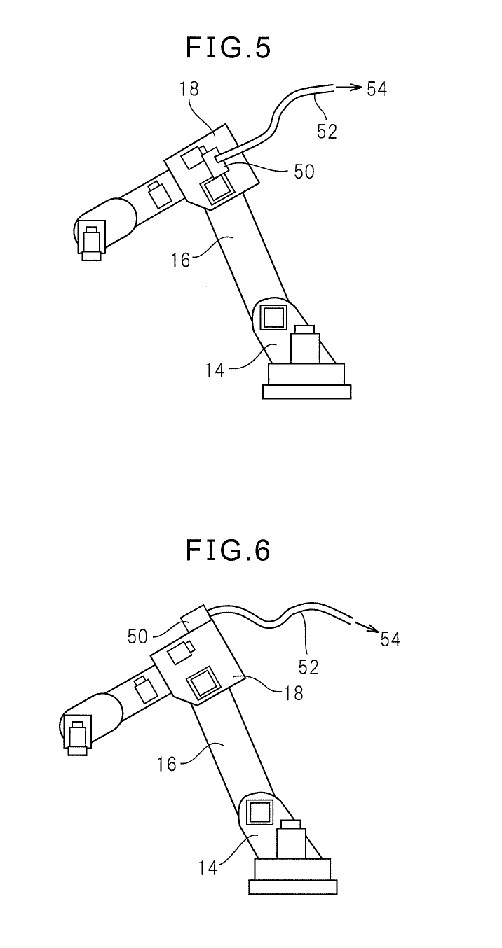

FIGS. 5 to 7 show modifications of the invention. In the embodiment of FIG. 1, cable outlet 50 is formed on a rear side of second arm 18 (in the specification, an operation side, i.e., a third wrist element 24 side is referred to as a “front side”). However, cable outlet 50 may be formed on a lateral side of second arm 18 as shown in FIG. 5, otherwise, may be formed on an upper side of second arm 18, as shown in FIG. 6.

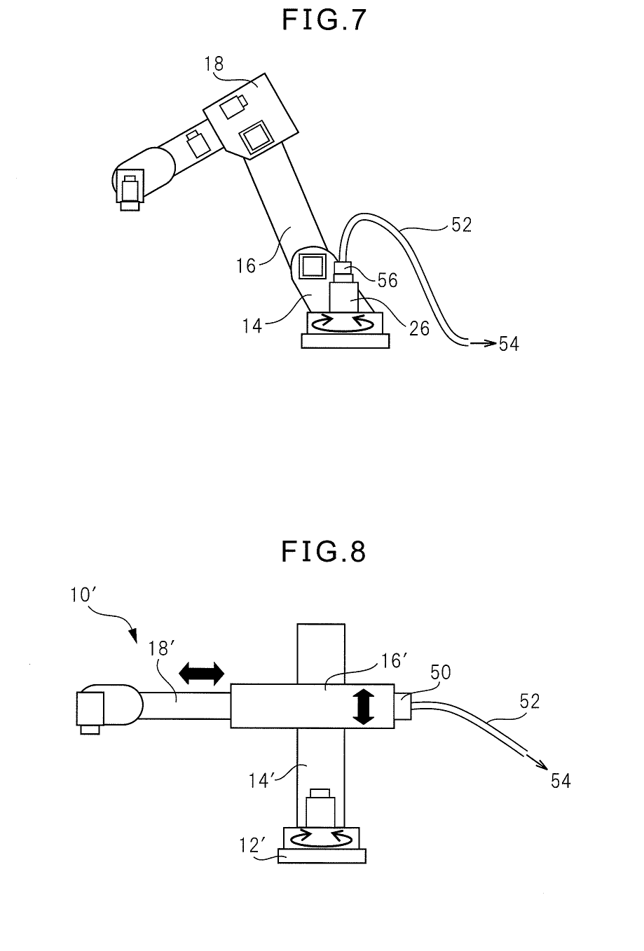

In the embodiment of FIG. 2, cable outlet 56 is formed on the rear side of rotating body 14. However, cable outlet 56 may be formed on the upper part of rotating body 14 (or the upper part of first motor 26), as shown in FIG. 7. When the outlet is formed on the center of rotation of rotating body 14 and the cable is withdrawn from the outlet in the upward direction, the stress applied to the cable due to the rotational motion of rotating body 14 can be accommodated by torsion of the cable.

As described above, the position of the cable outlet is not limited to the rear sides of the rotating body, the first arm and the second arm. However, when controller 54 is positioned near the rear side of robot 10, it is preferable that the cable outlet be formed on the rear side of one of the rotating boy, the first arm and the second arm. In FIGS. 5 to 7, the motor-drive cable from the outlet to each motor is not shown.

FIG. 8 shows an embodiment wherein first and second arms are linear axes. A multi-joint robot 10′ of FIG. 8 has a base 12′; a rotating body 14′ attached to base 12′ so as to rotate relative to base 12′; a first arm 16′ connected to rotating body 14′ so as to linearly move relative to rotating body 14′; and a second arm 18′ connected to first arm 16′ so as to linearly move relative to first arm 16′. Although the moving directions of first and second arms 16′ and 18′ are perpendicular to each other in the drawing, the relationship of the first and second arms is not limited as such. Cable outlet 50 is formed on the rear side of first arm 16′. The motor-drive cables from the motors are introduced to cable outlet 50, and then are withdrawn from outlet 50 as cable bundle 52 or separate cables, and are connected to robot controller 54. As such, the cable arrangement structure of the invention can also be applied to the multi-joint robot having the linearly moving arm.

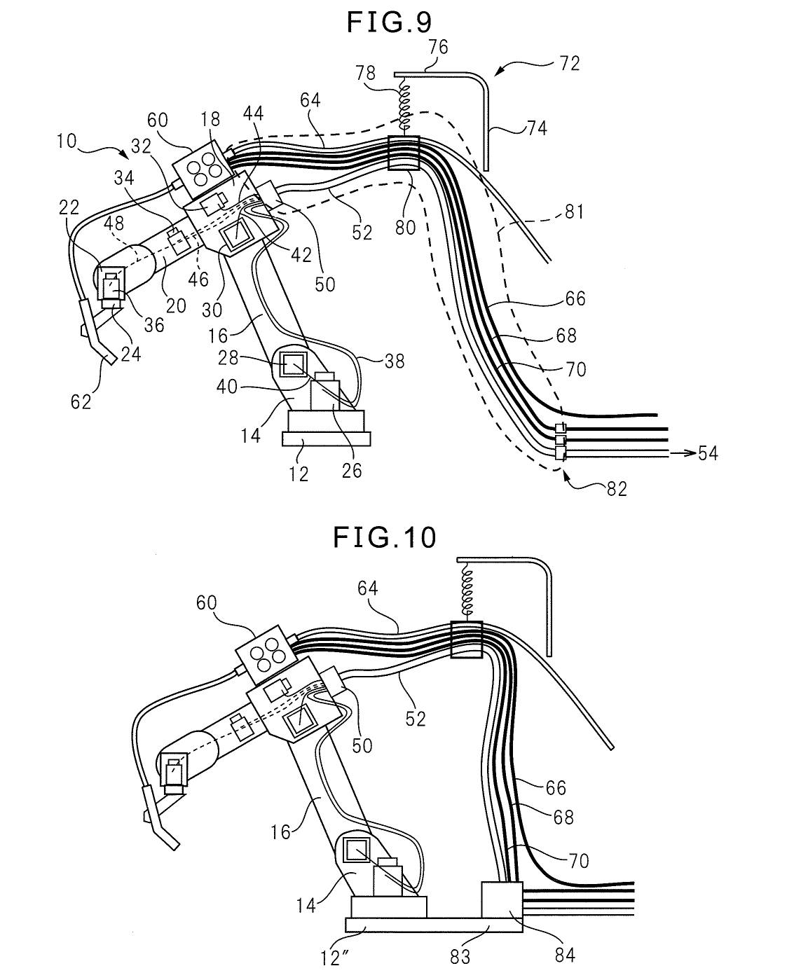

FIG. 9 shows an example wherein the present invention is applied to an arc-welding robot. Concretely, a wire feeder 60 and a welding torch 62 are attached to multi-joint robot 10 of FIG. 1. In the example of FIG. 9, wire feeder 60 is mounted on the upper part of second arm 18, and welding torch 62 is attached to third wrist element 24. A conduit 64 for supplying a wire is connected to wire feeder 60, and a welding wire is supplied from a wire supply (not shown). Wire feeder 60 is configured to feed the supplied wire to welding torch 62. A gas tube 66 and a welding-power cable 68, configured to supply welding gas and welding power to wire feeder 60, respectively, are connected to wire feeder 60. Further, a control cable 70 for controlling wire feeder 60 is connected to wire feeder 60. In addition, each component in FIG. 9, having the substantially same function as the component in FIG. 1, is provided with the same reference numeral as in FIG. 1, and the detailed explanation thereof is omitted.

Cable outlet 50 for the motor-drive cable is arranged on the rear side of second arm 18, and cable bundle 52 withdrawn from outlet 50 may be suspended by a suspending member such as a hanger 72, while the cable bundle is bound together with wire supplying conduit 64, gas tube 66, welding-power cable 68 and control cable 70 which are connected to wire feeder 60. For example, cable hanger 72 is a generally L-shaped rod member having a first straight portion (vertical portion) 74 arranged on the rear side of robot 10 and extending in the generally vertically upward direction, and a second straight portion (horizontal portion) 76 connected to a top of vertical portion 74 and extending in the generally horizontal direction. Cable hanger 72 has a spring 78 such as a coil spring having one end connected to or near a front end of horizontal portion 78, and a holding portion 80 such as a clamp, configured to collectively holding the above cables, connected to the other end of spring 78. As such, when the robot is a welding robot, the cables for welding and the motor-drive cable may be collectively arranged. Further, by a simple arrangement wherein the collected cables are suspended by cable hanger 72, stress applied to the cables can be lowered and interference between the cables and peripherals can be avoided.

Although the welding torch is used in the embodiment of FIG. 9, the present invention is also applied to a spot-welding robot wherein the welding torch is replaced with a spot gun.

As shown in FIG. 9, regarding motor-drive cable 52, welding power cable 68 and control cable 70, a part enclosed by a dashed line 81, i.e., from wire feeder 60 or outlet 50 to a mounting surface of robot 10 (or a portion of the cables suspended in the air by means of cable hanger 72), and a part of the cables extending at a level generally the same as the mounting surface, may be easily separated from each other by means of a relay member such as a relay connector 82. By virtue of this, when the cables are damaged in the part enclosed by dashed line 81 (which is likely to be damaged), only the damaged part may be easily replaced in a short time. In this regard, when the motor-drive cable is directly connected from the motor to relay connector 82, the cable between the motor and the relay connector, including the part enclosed in dashed line 81, is replaced with another cable.

By arranging an additional relay point on the motor-drive cable between the outlet and the motor, it is necessary to arrange a wire within a robot component such as the arm or the wrist element, whereby only the part enclosed by dashed line 81 may be replaced with another cable more easily. In view of the cost for arranging the relay point, the relay point may be arranged for only motor-drive cables 46 and 48 extending to the wrist elements. Further, it is effective for avoiding damage to the cables that cover the part enclosed by dashed line 81 by means of a protective member such as a protection cover or a spiral tube.

FIG. 10 is a view showing another example of the relay member, i.e., an alternative example of relay connector 82 of FIG. 9. The alternative example of FIG. 10 is different from FIG. 9 in that a base 12″ has an extended portion 83 extending in the generally horizontal direction toward the rear side of the robot, a relay box 84 is positioned on extended portion 83, and motor-drive cable 52, welding power cable 68 and control cable 70 are connected to relay box 84. By virtue of such a configuration, the effect similar to relay connector 82 of FIG. 9 can be obtained.

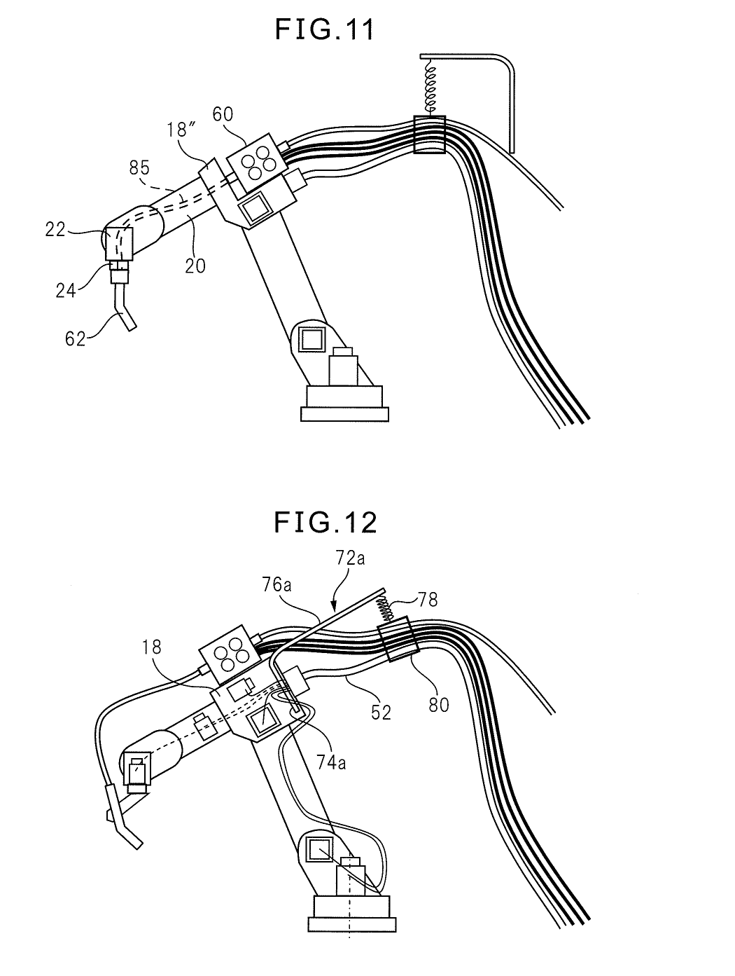

FIG. 11 is a view showing an alternative example of the positioning of wire feeder 60. The alternative example of FIG. 11 is different from FIG. 9 in that a second arm 18″ has a generally L-shape (or a concave portion) viewed from the lateral direction, wire feeder 60 is positioned in the concave portion, and a torch cable 85 for supplying a welding wire from wire feeder 60 to welding torch 62 is inserted into wrist elements 20, 22 and 24. The present invention can also be applied to the multi-joint robot as shown in FIG. 11, wherein the torch cable is disposed therein.

FIG. 12 is a view showing an alternative example of the cable hanger. A cable hanger 72a of FIG. 12 is similar to cable hanger 72 of FIG. 9 in that cable hanger 72a is also a generally L-shaped rod member. However, cable hanger 72a is different from cable hanger 72 in that, among two straight members constituting the generally L-shape, a first straight member 74a is attached to the rear side of second arm 18, and a second straight member 76a extends from one end of first straight member 74a toward in the rear direction. Similarly to the example of FIG. 9, spring 78 such as a coil spring is connected to or near a front end of second straight member 76a, and holding portion 80 such as a clamp, configured to collectively holding the cables, connected to the other end of spring 78. Therefore, the function and effect of cable hanger 72a is similar to cable hanger 72 of FIG. 9. However, since cable hanger 72a of FIG. 12 is not positioned on the fixed part other than the robot body, the installation area of the robot including the cable hanger can be more compact than the embodiment of FIG. 9. In addition, although cable hanger 72a is attached to second arm 18, the cable hanger may be attached to the first arm or the rotating body.

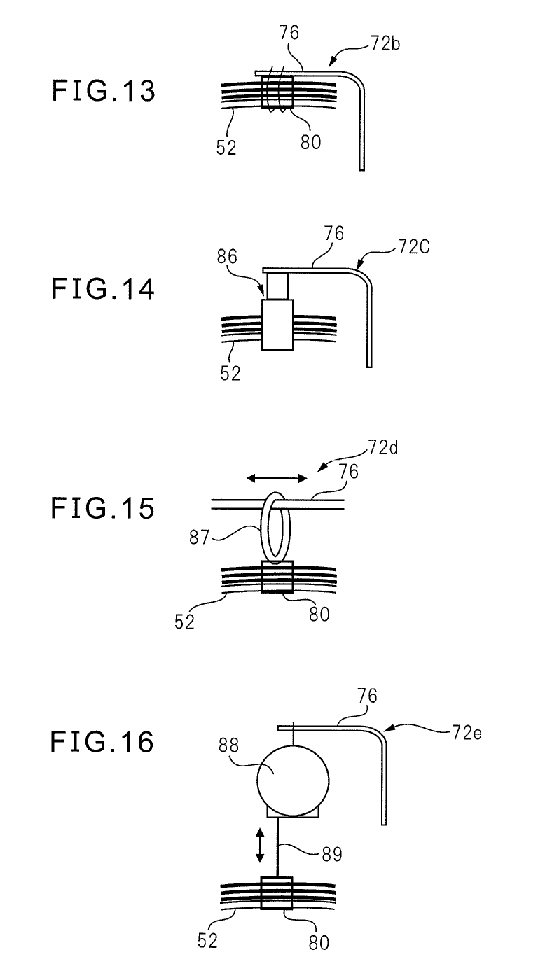

FIGS. 13 to 16 show other examples of the cable hanger. First, in a cable hanger 72b as shown in FIG. 13, a spring is not provided, and holding portion 80 is directly fixed to second straight member 76. In cable hanger 72 having spring 78 of FIG. 9, the cables including motor-drive cable 52 may be vertically displaced relative to cable hanger 72. On the other hand, the embodiment of FIG. 13 is adapted to limit the movable range of the cables.

In a cable hanger 72c as shown in FIG. 14, a holding member 86 such as a bearing, for rotatably holding the cables about the longitudinal direction thereof, is attached to second straight member 76. The embodiment of FIG. 14 is suitable when the cable is likely to be twisted.

In a cable hanger 72d as shown in FIG. 15, a holding portion 80 such as a clamp for holding the cables is connected to a ring member 87, and second straight member 76 is inserted into ring member 87. In other words, ring member 87 is movable relative to second straight member 76. The embodiment of FIG. 15 is adapted to allow the cables to move also in the longitudinal direction thereof.

In a cable hanger 72e as shown in FIG. 16, spring 78 of the cable hanger of FIG. 9 is replaced with a spring balancer 88, and holding portion 80 for holding the cables is connected to a wire 89 of spring balancer 88. The embodiment of FIG. 16 is suitable when the weight of the cables is relatively high.

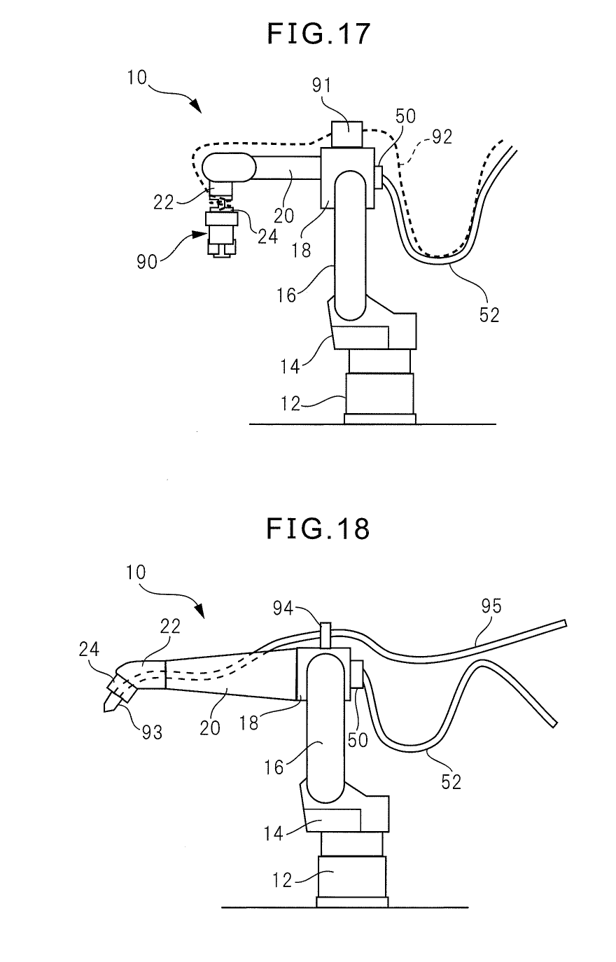

FIG. 17 is a view showing an example wherein the present invention is applied to a material handling robot. Concretely, a robot hand 90 and an electromagnetic valve box 91 are provided to a multi-joint robot having the constitution equivalent to multi-joint robot 10 of FIG. 1. In the example of FIG. 17, hand 90 is attached to third wrist element 24, and valve box 91 is mounted on second arm 18. A tube 92 for the hand, such as an air tube from a supply source (not shown) and an electromagnetic valve cable, is connected to valve box 91, so that controlled air and signals are sent to hand 90 by means of valve box 91. Cable outlet 50 is formed on the rear side of second arm 18, and motor-drive cable 52 withdrawn from outlet 50 may be arranged along with tube 92.

FIG. 18 is a view showing an example wherein the present invention is applied to a painting robot. Concretely, a painting gun 93 and a tube holder 94 are provided to a multi-joint robot having the constitution equivalent to multi-joint robot 10 of FIG. 1. In the example of FIG. 18, painting gun 93 is attached to third wrist element 24, and tube holder 94 is mounted on second arm 18. Tube holder 94 holds a tube 95 for supplying paint from a paint supply source (not shown). Tube 95 is introduced into first wrist element 20 from an opening formed on the first wrist element, and is connected to painting gun 93 after extending through second and third wrist elements 22 and 24. Cable outlet 50 is formed on the rear side of second arm 18, and motor-drive cable 52 withdrawn from outlet 50 may be arranged along with tube 95. Of course, each cable hanger, the relay connector and the relay box, which are explained with reference to FIGS. 9 to 16, may also be applied to the embodiments of FIGS. 17 and 18.

As shown in FIGS. 9, 17 and 18, when the cable arrangement structure of the invention is applied to the various robots, cables and/or tubes required for the usage of the robot (a wire conduit, an air tube, a tube for supplying paint, etc.) and the motor-drive cable withdrawn from the cable outlet may be collectively arranged by means of the cable hanger, etc., whereby the arrangement of the cables around the robot, which is likely to be complicated, may be easily carried out by means of inexpensive components.

According to the present invention, it is not necessary to form a space in the base for the motor-drive cable, whereby the entire robot may be compact and the attachment and the replacement of the cable may be easily carried out. Further, since it is not necessary to prepare a space at the rear side of the base for arranging the cable, a plurality of robots may be positioned close to each other.

By using only one cable outlet, and/or by withdrawing all of the motor-drive cables of the multi-joint robot from the outlet, the arrangement of the cable is further facilitated.

By using the suspending member for suspending the motor-drive cable between the multi-joint robot and the robot controller, the motor-drive cable and the other cable such as a wire conduit used in the robot can be collectively arranged.

By using the relay member between the motor and the robot controller, to which the motor-drive cable may be detachably connected, the motor-drive cable can be easily replaced with another cable when the cable is damaged between the multi-joint robot and the robot controller.

While the invention has been described with reference to specific embodiments chosen for the purpose of illustration, it should be apparent that numerous modifications could be made thereto, by one skilled in the art, without departing from the basic concept and scope of the invention.

1. A cable arrangement structure for a multi-joint robot comprising:
a base;
a rotating body attached to the base so as to rotate relative to the base;
a first arm attached to the rotating body so as to rotate or linearly move relative to the rotating body; and
a second arm connected to the first arm so as to rotate or linearly move relative to the first arm,
wherein a motor-drive cable is introduced from each motor to a cable outlet which is formed only on at least one of the rotating body, the first arm and the second arm; is withdrawn from the cable outlet; and is connected to a robot controller for controlling the multi-joint robot, the motor-drive cable being constituted by a power cable for supplying power to each of motors for respectively driving the rotating body, the first arm and the second arm, and a signal cable for transmitting and/or receiving a signal to and/or from each of the motors.

2. The cable arrangement structure as set forth in claim 1, wherein the motor-drive cable is introduced from each motor to the cable outlet which is formed only on one of the rotating body, the first arm and the second arm; is withdrawn from the cable outlet; and is connected to the robot controller for controlling the multi-joint robot.

3. The cable arrangement structure as set forth in claim 1, wherein a motor-drive cable is introduced from each motor to a cable outlet which is formed only on at least one of the rotating body, the first arm and the second arm; is withdrawn from the cable outlet; and is connected to a robot controller for controlling the multi-joint robot, the motor-drive cable being constituted by a power cable for supplying power to each of all motors provided to the multi-joint robot, and a signal cable for transmitting a signal to each of the all motors.

4. The cable arrangement structure as set forth in claim 1, comprising a suspending member which suspends the motor-drive cable between the multi-joint robot and the robot controller.

5. The cable arrangement structure as set forth in claim 1, comprising a relay member positioned between the motor and the robot controller, the relay member being configured to be detachably connected to the motor-drive cable.

6. The cable arrangement structure as set forth in claim 1, comprising a protective member which covers a portion of the motor-drive cable between the multi-joint robot and the robot controller.

7. The cable arrangement structure as set forth in claim 1, wherein the multi-joint robot is an arc-welding robot, a spot-welding robot, a material handling robot or a painting robot.
